(19) United States
(12) Patent Application Publication
(10) Pub. No.: US 2009/0134332 A1
(43) Pub. Date: May 28, 2009

(54) Infrared Encoded Objects and Controls for Display Systems

(76) Inventors: Jason R. Thompson, Dallas, TX (US); Harold E. Bellis, II, Garland, TX (US)

Correspondence Address: TEXAS INSTRUMENTS INCORPORATED, P O BOX 655474, M/S 3999, DALLAS, TX, 75265, US

(21) Appl. No.: 11/945,925

(22) Filed: Nov. 27, 2007

(51) Int. Cl. G01J 5/02

(52) U.S. Cl. 250/348; 345/207

(57) ABSTRACT

A system for displaying images comprises a plurality of light sources, comprising at least one non-visible light source. The system further comprises a spatial light modulator operable to modulate non-visible light from the non-visible light source to encode one or more objects and for presentation on a display. Finally, the system comprises a detector operable to detect at least a portion of the non-visible light presented on the display.

### TECHNICAL FIELD

This disclosure relates in general to displays, and more particularly to encoding of infrared objects within an image on the display.

### OVERVIEW

Digital light processing (DLP®) systems create images using microscopically small mirrors laid out on a digital micromirror device (DMD). A DMD is a light modulator, a class of devices that may be used to modulate a source light beam into an image suitable for display on a surface. The micromirrors on the DMD can be individually rotated to an on or off state rapidly and produce different shades of colors. The rapid changing of the colors of each pixel produces images on the display. Users of a DLP® system can then view the images on the display. Existing technologies, however, are limited in offering users a method for providing feedback to the DLP® system and interacting with the system in other ways.

### SUMMARY OF EXAMPLE EMBODIMENTS

In accordance with one embodiment of the present disclosure, a system for displaying images comprises a plurality of light sources, comprising at least one non-visible light source. The system further comprises a spatial light modulator operable to modulate non-visible light from the non-visible light source to encode one or more objects and for presentation on a display. Finally, the system comprises a detector operable to detect at least a portion of the non-visible light presented on the display.

In accordance with another embodiment of the present disclosure, a method for displaying images comprises generating a visible image using one or more light sources. The method further comprises modulating, by a spatial light modulator, non-visible light from a non-visible light source with the visible image to encode one or more objects. The method further comprises displaying the visible image and the modulated non-visible light on a display. The method further comprises detecting the non-visible light on the display.

Technical advantages of this disclosure include the ability to use non-visible light for built-in interaction with a DLP® system. DLP® systems provide advantages over other display systems because of their fast switching times, thus allowing the display to rapidly adjust to feedback from the detector or the participant.

Other technical advantages of the present disclosure will be readily apparent to one skilled in the art from the following figures, descriptions, and claims. Moreover, while specific advantages have been enumerated above, various embodiments may include all, some, or none of the enumerated advantages.

### BRIEF DESCRIPTION OF THE DRAWINGS

For a more complete understanding of the present disclosure and its advantages, reference is now made to the following description, taken in conjunction with the accompanying drawings, in which:

FIG. 1 illustrates one embodiment of a system for creating infrared encoded objects for display;

FIG. 2 illustrates another embodiment of a system for creating infrared encoded objects for display;

FIG. 3 shows two embodiments of a color wheel for use with a system for creating infrared encoded objects for display;

FIG. 4 illustrates one embodiment of objects on a display encoded with infrared radiation; and

FIG. 5 is a flowchart illustrating an example method of creating infrared encoded objects for display.

### DETAILED DESCRIPTION

A DMD can modulate not only visible light, but also non-visible light, such as infrared or ultraviolet light. For example, if the source light beam in the DLP® system includes non-visible infrared light, the infrared light can be modulated and transmitted to the display along with the visible images. Infrared detectors can interact with the infrared light and allow user participation with the DLP® system.

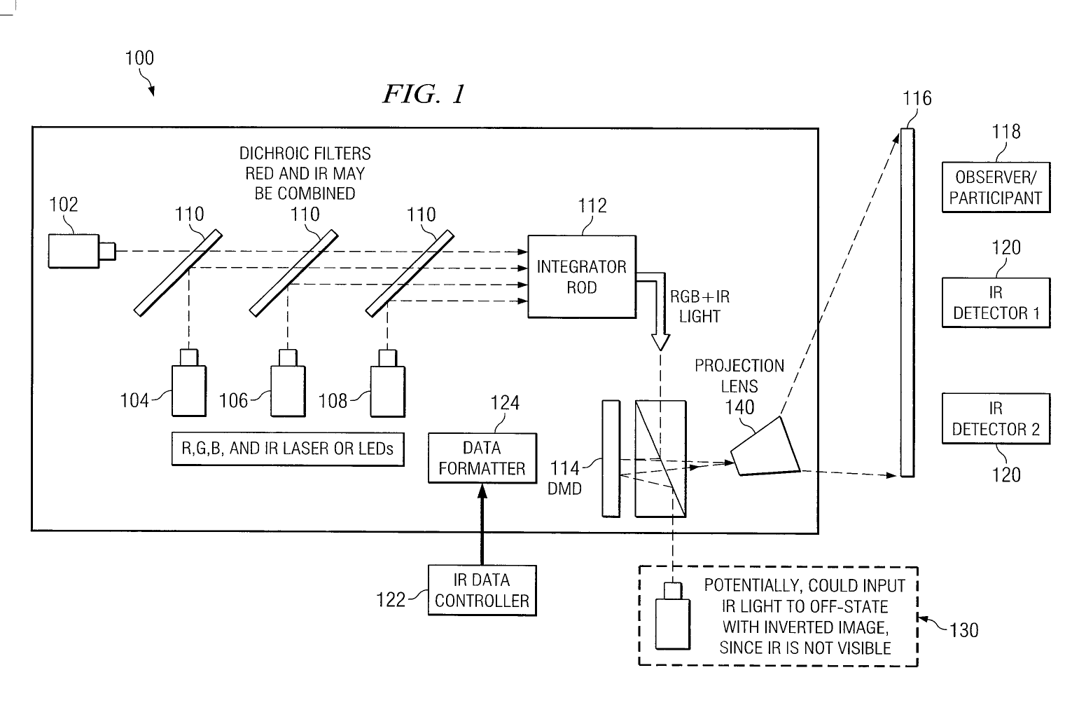

FIG. 1 shows one embodiment of a DLP® system that uses infrared light to encode objects on a display. DLP® system 100 comprises one or more light sources 102, 104, 106, and 108. Light sources in a DLP® system can be lamps, light emitting diodes (LEDs), infrared laser light, or any other suitable light source. System 100 can also comprise any suitable number of light sources. In FIG. 1, light sources shown in system 100 are red, green, blue, and infrared sources. In certain embodiments, light from light sources 102, 104, 106, and 108 can be passed through one or more dichroic filters 110. Dichroic filters are used to selectively pass only certain wavelengths of light, while reflecting other wavelengths. In some embodiments, system 100 also includes an integrator rod 112 that can combine the light from the light sources before they are sent to digital micromirror device 114 (DMD). The micromirrors on DMD 114 reflect the images created by light sources 102, 104, 106, and 108 onto display 116. Display 116 can comprise a front or rear projection screen, or any other technology suitable for displaying images. DMD 114 reflects not only visible light but also infrared light, so infrared light in system 100 is sent to display 116 as well. This allows infrared light to be sent through projection lens 140 to be emitted from display 116, much the same way as visible light is. Observer/participant 118 using system 100 can view the visible light images from display 116. Observer 118 can also use one or more infrared detectors 120 to detect the infrared light from system 100. Infrared detectors 120 can react to infrared light from system 100, and transmit information to infrared data controller 122 for processing, feedback, or other uses within system 100.

A brief overview of a DLP® system will be useful in understanding the present disclosure. Micromirrors are laid out in a matrix on DMD 114. Each micromirror on DMD 114 represents one or more pixels of the image projected onto display 116. Each individual micromirror can be repositioned rapidly, tilting toward the light source to turn it “ON” and away from the light source to turn it “OFF.” The greater the ratio of “ON” time to “OFF” time produces a lighter pixel. More “OFF” time produces a darker pixel. In some embodiments, colors can be added to the visible light by the use of a color wheel. The micromirrors can be repositioned rapidly and synchronized to create the images projected on display 116. While they are reflecting visible light to create images, the micromirrors can also reflect infrared light onto display 116. This infrared light can be detected by infrared detectors 120 and used by system 100 to perform a variety of actions.

Infrared data controller 122 can be used to perform a number of functions in system 100. For example, infrared detectors 120 can detect the location of objects on display 116 that have been encoded with infrared light. Infrared detectors 120 can then transmit that location information to data controller 122. This location information can be used by data controller 122 and/or data formatter 124 to modify the objects on display 116. In one embodiment, infrared detector 120 may take the form of a game controller with input buttons for use by user 118 in a video game. One or more objects on display 116 may be encoded with infrared information for detection by infrared detector 120. If user 118 pushes a button while the one or more objects are detected by infrared detector 120, the infrared detector 120 can transmit that information to data controller 122. Data controller 122 and/or data formatter 124 can then direct the video game system to take an appropriate action.

Infrared detectors 120 can take a variety of forms and perform a variety of detecting functions, all of which fall within the scope of this disclosure. For example, infrared detectors 120 can receive X and Y coordinate information from the infrared encoded objects on display 116. The X and Y coordinate information can be used by system 100 to determine the absolute or relative position of objects on display 116. This position information might, for example, be used by a recreational or educational program utilizing system 100. Infrared detectors 120 can also be configured to detect movement of one or more objects on display 116. When an infrared-encoded object moves on display 116, X and Y coordinate information can be detected by one or more infrared detectors 120 and can be compared to previous coordinate information, allowing infrared detector 120, data controller 122, and/or data formatter 124 to determine the speed and/or direction of motion of the infrared encoded object on display 116. Velocity or motion data can be used to provide feedback to user 118, modify the images on display 116, or take any other action as requested by system 100.

Infrared detectors 120 in certain embodiments may also detect the intensity of infrared radiation from an infrared-encoded object. One or more objects on display 116 can be encoded with an intensity level selected from two or more degrees of intensity. Infrared detector 120 can differentiate among those degrees of intensity and transmit that information to data controller 122. Intensity information can be used to differentiate between infrared-encoded objects on the display. For example, infrared detector 120 and/or data controller 122 can take a certain action when a high-intensity encoded object is detected, and can take a different action if a low-intensity encoded object is detected. The intensity of infrared radiation of an object on display 116 can also be used in conjunction with the intensity of visible light of the object. In this embodiment, the visible light intensity can serve as a proxy for infrared intensity. This allows user 118 to interact with system 100 based upon infrared intensity even though user 118 cannot directly see the infrared radiation.

In another embodiment, infrared radiation can be input into the system using infrared source 130. Infrared source 130 can be comprised of one or more lamps, LEDs, infrared laser light sources, or any other suitable light sources. In some embodiments, infrared radiation is not passed through dichroic filters 110 and integrator rod 112. Instead, infrared source 130 inputs infrared light directly to DMD 114 during an off-state. The infrared light is then sent to the display where it can be detected by infrared detectors 120. In yet another embodiment, infrared light source 130 can pass light through one or more dichroic filters, integrator rods, or colorwheels to filter the light before the light reaches DMD 114.

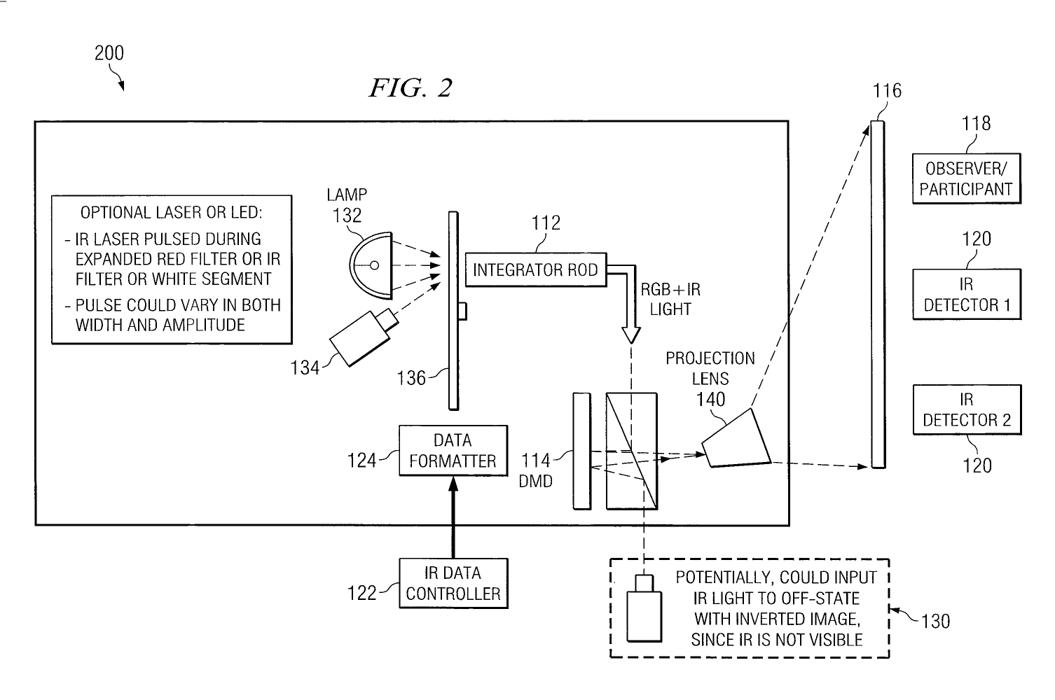

FIG. 2 shows another embodiment 200 of the present disclosure. Here, the DLP® system works similarly to the system described in FIG. 1. However, in FIG. 2 a lamp 132 is used as a light source instead of the separate light sources as described in FIG. 1. Infrared laser source 134 can comprise the infrared radiation source. In certain embodiments, lamp 132 can produce infrared light in addition to, or instead of, infrared laser source 134. Visible light from lamp 132 is passed through a color wheel 136. Color wheel 136 rotates to provide color to the light from lamp 132, depending on which color needs to be sent to display 116 at any given time. The light then passes through integrator rod 112 and on to DMD 114, where it is reflected by the micromirrors onto display 116. Otherwise system 200 operates in an analogous fashion to the operation of system 100, illustrated in FIG. 1.

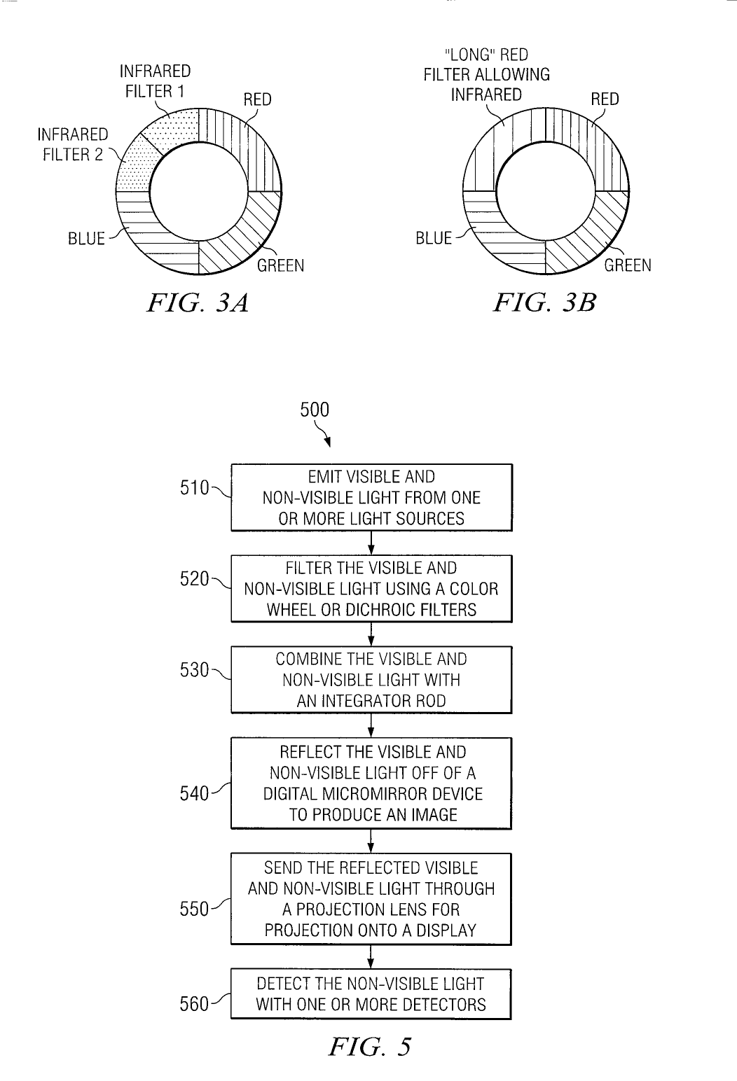

FIG. 3 shows two examples of color wheels that allow infrared light to pass. FIG. 3A is a color wheel with filters for red, green, blue, infrared filter 1, and infrared filter 2. The red, green, and blue filters pass the respective wavelengths of visible light associated with those colors, and the infrared filters pass the infrared wavelengths of the light. Red light has a wavelength of about 650 nanometers. Green light has a wavelength of about 510 nanometers, and blue light has a wavelength of about 475 nanometers. Infrared radiation has wavelengths approximately between 750 and 1000 nanometers and is largely invisible to the human eye. A color wheel can have one or more infrared filters. As an example, two infrared filters are shown in FIG. 3A. Two infrared filters can be used instead of one so that two different wavelengths of infrared light can be passed separately. Passing two separate wavelengths of infrared light allows for greater control over infrared-encoded objects than merely utilizing one infrared filter. Infrared detectors 120 can be designed to detect these two distinct wavelengths of infrared light, allowing for greater differentiation among objects encoded with infrared radiation on display 116. Some objects can be encoded with infrared wavelength 1, and other objects encoded with infrared wavelength 2. Infrared detectors 120 can provide feedback to data controller 122 based upon which infrared wavelength is detected.

Alternatively, the infrared radiation can be passed by a “long” red filter as depicted in FIG. 3B. Here, the bandwidth of the red filter is extended so that it passes not only red wavelengths but also any infrared wavelengths for use in system 100. Either of the filters depicted in FIG. 3, or any other appropriate filter, can be used as the color wheel in FIG. 2.

Infrared light is a suitable choice for use in a DLP® system to encode objects for a variety of reasons. Infrared light does not cause harm like other types of radiation, for example ultraviolet light. Also, infrared lasers are well-developed and used in a variety of applications, so they have become efficient and relatively inexpensive to use compared to other technologies.

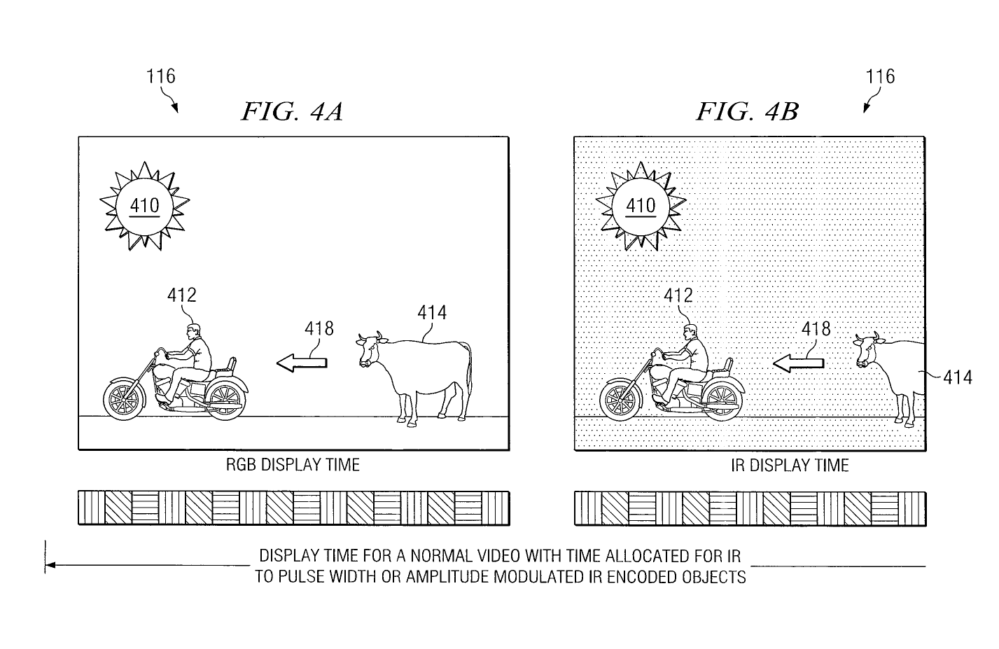

FIG. 4 shows an example embodiment of infrared-encoded objects on a display 116. FIG. 4A shows an image on display 116 created by a DLP® system 100. When the red, green, and blue wavelengths are passed through system 100, the images in FIG. 4A are transmitted to display 116. The red, green, and blue wavelengths are displayed at a rate sufficiently high so that a user 118 (not shown) viewing display 116 sees a solid image. For example, user 118 could see sun 410, boy 412, bull 414, and motion 418 on display 116. Motion 418 is not an object on the display like the other objects. The arrow is used to symbolize the movement of bull 414 across the screen towards boy 412. User 118 would not see the arrow, but would instead see bull 414 move across display 116.

While those visible images are displayed on display 116, the infrared radiation used to encode the objects is also transmitted through system 100 and sent to display 116. An example of this is shown in FIG. 4B. The infrared radiation is non-visible to participant 118, but will be detected by infrared detectors 120. For example, in FIG. 4B sun 410 may appear yellow to an observer, but it is also encoded with infrared radiation. Infrared detector 120 will detect that infrared radiation and then interact with system 100 in a variety of ways. Infrared detector 120 might transmit a signal to data controller 122 notifying data controller 122 that the sun 410 has been detected. Data controller 122 and/or data formatter 124 may then take one or more actions based on this information. Data controller 122 may, for example, move the sun 410 across the display. Data controller may also increase or decrease the intensity of visible light associated with sun 410, thus providing visible feedback to user 118. Infrared radiation representing boy 412 and bull 414 can also be detected by one or more infrared detectors 120.

In some embodiments, infrared detectors like infrared detector 120 can also be used to sense motion of an object on display 116. For example, if bull 414 moves across display 116 toward boy 412, infrared detector 120 can detect that movement and send information regarding that movement to data controller 122 for use within system 100. User 118 in system 100 can use infrared detector 120 and infrared data controller 122 to respond to the motion of the objects on display 116. In certain embodiments user 118 might use a button on infrared detector 120 to send a response to data controller 122 to indicate that user 118 sees the motion. That response can then be used to alter the location or movement of one or more objects on display 116.

In one embodiment of this disclosure, the infrared-encoded objects can be used in a video game system. For example, infrared detectors 120 can be in the form of a gun for use in a shooting game. When an infrared encoded target appears on the screen, user 118 can pull a trigger or perform some other action to send a signal to infrared data controller 122 to provide feedback to the video game. Data controller 122 and/or data formatter 124 can use all or at least a portion of this feedback to alter one or more of the objects displayed on display 116. For example, the infrared encoded target may move on display 116 or may be removed from display 116 because of user 118's actions. A variety of other movements or actions can be taken by user 118 in response to objects or motion on display 116. Similarly, numerous types of video games can be used in conjunction with system 100, including sports, action, adventure, strategy, or simulation games.

In certain embodiments, system 100 can be used for educational purposes as well. The infrared information and the visual objects on display 116 can provide feedback to user 118 in response to actions taken by user 118. In addition, data controller 122 and/or data formatter 124 can be used to alter the images or objects on display 116. As an example, infrared detector 120 can be in the shape of a pen that user 118 uses to interact with system 100. The pen can be used to track an object on display 116, or can be used to relay location information of an object on display 116 to data controller 122 so that the objects can be altered in response to the movement of the pen. In certain embodiments, system 100 can also be used with 3D glasses. The infrared signals can be used to synchronize 3D glasses for use with a DLP® display.

FIG. 5 is a flowchart describing one method 500 of displaying objects encoded with non-visible light. In particular, the illustrated technique can encode one or more objects with non-visible light for display and detection. The steps illustrated in FIG. 5 may be combined, modified, or deleted where appropriate. Additional steps may also be added to the example operation. Furthermore, the described steps may be performed in any suitable order. In step 510, visible and non-visible light are emitted from one or more light sources 102, 104, 106, and 108 (which can be red, green, blue, and infrared sources, respectively). Light can also be emitted from lamp 132 and a non-visible light source like infrared laser source 134. The light sources in step 510 can be lamps or light-emitting diodes or any other suitable light source. The light sources can also comprise any suitable number of light sources. The visible light from the light sources can be used to create the images on display 116, and the non-visible light can be used to encode one or more of the objects on display 116.

In step 520 the visible and non-visible light is filtered using a color wheel 136 or dichroic filters 110. In certain embodiments, light from a light source can be passed through color wheel 136. Color wheel 136 rotates to provide color to the light from lamp 132, depending on which color needs to be sent to display 116 at any given time. Color wheel 132 may also filter wavelengths corresponding to non-visible light, so that non-visible light can also be sent through the system. Some embodiments may utilize one or more dichroic filters 110 to filter one or more wavelengths separately. In certain dichroic filters 110, non-visible light can be filtered along with visible light. For example, red light and infrared light can be filtered together with a properly designed dichroic filter 110.

In step 530 the visible and non-visible light is combined with an integrator rod 112. Integrator rod 112 can homogenize the filtered light output from dichroic filters 110 or color wheel 132 into a single stream of light consisting of visible and non-visible wavelengths. Integrator rod 112 can also convert the visible and non-visible light into a uniform pattern, such as a rectangle, for use with DMD 114.

In step 540 the visible and non-visible light is selectively reflected with the micromirrors on DMD 114 to produce an image on display 116. The micromirrors are rotated between ON and OFF positions to produce the desired images on display 116. While the visible light is being reflected to produce an image that can be seen by a user, the non-visible light can also be sent to display 116 in patterns suitable for use with system 100.

In step 550 the reflected visible and non-visible light is sent through projections lens 140 for projection onto display 116. Projection lens 140 comprises any type of projection lens operable to project the image onto display 116. Projection lens 140 is also operable to project non-visible light onto display 116. Display 116 comprises a front or rear projection screen, or any other technology suitable for displaying images.

In step 560 the non-visible light projected to display 116 is detected with one or more detectors 120. Detectors 120 comprise any suitable apparatus or device operable to sense any type of non-visible light. For example, detectors 120 could be handheld devices that detect infrared radiation emitted according to method 500. Detectors 120 can also be any suitable shape or size, such as in the shape of a pen, a video game controller, or a toy gun. Detectors 120 can also be operable to transmit information about the detected non-visible light, or input information from user 118, to data controller 122 or another device for further use with system 100 or system 200. In certain embodiments, detectors 120 can provide feedback to user 118 via lights or sounds. Detectors 120 may also employ a motion feedback system to provide information to user 118.

Although the present disclosure has been described with several embodiments, a myriad of changes, variations, alterations, transformations, and modifications may be suggested to one skilled in the art, and it is intended that the present disclosure encompass such changes, variations, alterations, transformations, and modifications as fall within the scope of the appended claims.

What is claimed is:

1. A system for displaying images, comprising:
a plurality of light sources, comprising at least one non-visible light source;
a spatial light modulator operable to modulate non-visible light from the non-visible light source to encode one or more objects and for presentation on a display; and
a detector operable to detect at least a portion of the non-visible light presented on the display.

2. The system of claim 1, wherein the at least one non-visible light source is an infrared light source.

3. The system of claim 1, wherein the spatial light modulator is a digital micromirror device.

4. The system of claim 1, wherein the at least one non-visible light source is selected from the group consisting of a lamp, a laser, or a light emitting diode.

5. The system of claim 4, wherein a color wheel is used to filter light from the lamp.

6. The system of claim 1, wherein the detector sends detected information to a data controller.

7. The system of claim 6, wherein the data controller adjusts one or more objects on the display based at least in part on the detected information.

8. The system of claim 1, wherein the at least one non-visible light source is operable to input non-visible light to the spatial light modulator during an off state of the spatial light modulator.

9. The system of claim 1, wherein the at least one non-visible light source is operable to input non-visible light to the spatial light modulator during an on state of the spatial light modulator.

10. The system of claim 9, wherein a dichroic filter is used to combine the non-visible light with visible light.

11. A method for displaying images, comprising:
generating a visible image using one or more light sources;
encoding one or more objects by modulating, by a spatial light modulator, non-visible light from a non-visible light source with the visible image;
displaying the visible image and the modulated non-visible light on a display; and
detecting the non-visible light on the display.

12. The method of claim 11, wherein encoding one or more objects comprises encoding position of an object on the display.

13. The method of claim 11, wherein encoding one or more objects comprises encoding movement of an object on the display.

14. The method of claim 11, wherein detecting the non-visible light on the display further comprises transmitting the detected non-visible light to a data controller.

15. The method of claim 14, wherein the data controller adjusts one or more objects on the display based at least in part on the detected non-visible light.

16. The method of claim 11, wherein modulating non-visible light comprises modulating non-visible light during an off-state of the spatial light modulator.

17. The method of claim 11, wherein modulating non-visible light comprises modulating non-visible light during an on-state of the spatial light modulator.

18. The method of claim 11, wherein displaying the modulated non-visible light comprises displaying at least a portion of the non-visible light with varying intensity.

19. The method of claim 11, wherein the detector is operable to detect movement of an object on the display, based at least in part on a portion of the non-visible light.

20. The method of claim 11, wherein the detector is operable to detect position of an object on the display, based at least in part on a portion of the non-visible light.

21. A gaming system, comprising:
a plurality of light sources, comprising a lamp and at least one infrared light source;
a color wheel operable to filter light from the lamp;
a digital micromirror device operable to modulate infrared light from the infrared light source for encoding one or more objects and for presentation on a display; and
one or more detectors operable to detect at least a portion of the infrared light presented on the display and send one or more signals to a data controller, the one or more signals being based at least in part on feedback from one or more users, and wherein the data controller is operable to adjust one or more encoded objects on the display based at least in part on the detected infrared light.
